(19) United States
(12) Patent Application Publication
(10) Pub. No.: US 2006/0282320 A1
(43) Pub. Date: Dec. 14, 2006

(54) Targeted advertisement network that integrates with store-shopping

(76) Inventor: Jianfeng Jiang, San Jose, CA (US)

Correspondence Address: Jianfeng Jiang, 1075 McKay Dr., San Jose, CA, 95131, US

(21) Appl. No.: 11/409,200

(22) Filed: Apr. 24, 2006

Related U.S. Application Data
(63) Continuation of application No. 11/148,117, filed on Jun. 9, 2005.

(51) Int. Cl. G06Q 30/00

(52) U.S. Cl. 705/14

(57) ABSTRACT

A new targeted Advertisement network that integrates with store-shopping includes at least one on-line provider of advertisements, a network of computers with assigned attributes for displaying the advertisements, a software collecting the assigned attributes of the computers and delivering the advertisements to the computers accordingly, and a desktop program installed in each computer to run the ads and interface with viewers.

### FIELD OF INVENTION

This invention relates to on-line shopping, on-line gaming, on line entertainment, on line advertisements, out-of-home advertisements and e-commerce.

### BACKGROUND OF THE INVENTION

Advertisements are one of the most essential parts of business. They exist everywhere, from Radio to TV, from magazines to newspapers. The latest successful ones are the internet web-sites, like Yahoo & Google, etc.

There are also some companies who install many devices like flat panel DVD players in public places, then store all the advertisements in the DVDs and simply play the DVDs.

However, none of the above mentioned advertise methods can deliver ads in real time and targeting specific places and specific people in public places like stores, airports, etc.

Also, none of the above mentioned advertise methods have been able to combine the benefits of both traditional store shopping and on-line shopping, where preferably the shoppers can walk through the isles and see all the Ads. And preferably once the shopper decides to buy a product in the Ad, he can either pay with a credit card instantly or be given a code linked to the displayed product which the shopper can provide to a cashier for scanning.

The proposed network put computers in many public places, in stores along with different isles, in airport waiting areas, alongside the walking streets, etc. The shopping interest of people at above mentioned different places are different. In the stores, a shopper is looking for related goods in that specific isle. While in airport waiting areas, the viewers' shopping interests are more general, but the viewers' profile like income level, age, and shopping interest etc are still different for different places.

In short, the viewers' shopping profiles are different at different locations & different times, these shopping profiles will be decided by the person in charge of that specific displaying computer. With the knowledge of the shopping profiles, the ads can be delivered to these computers according to their viewers' shopping needs. In this way, advertisers can pay less and achieve better results.

The proposed advertisement network can also be integrated with store-shopping using the method proposed in the patent by the same author “On Line Shopping Network that Integrates with Store-Shopping” Ser. No. 10/926,413.

Basically, if a shopper is interested in buying a product in the ad, he can either pay through credit card, or he can take a coupon, or print out a ticket for that product and check out with the Cashier.

Furthermore, all the products shown in the ads are listed in the affiliated web-site of the new targeted-advertisement network, the shopper can always check out from the web-site.

Therefore the proposed new advertisement network combines the benefits of both e-commerce and traditional broadcastings, so that the ads can be broadcasted at specific time slots and at specific places targeting specific groups of shoppers, the shoppers can also check out from the computers, or print out a ticket and check out with the cashier like traditional shopping. In this way, e-commerce & traditional shopping are conveniently integrated.

### SUMMARY OF THE INVENTION

In accordance with one aspect of the invention, the new targeted advertisement network that integrates with store-shopping allows the store managers to decide the shopping profiles of the viewers for each computer he is deploying in his store, he then recommends which categories of goods or Ads fit each computer. These profiles can be updated any time by the manager.

In accordance with another aspect of the invention, the network management software for the new targeted advertisement network gathers all the profiles for each computer and delivers the Ads to the computers accordingly.

In accordance with one other aspect of the invention, the advertisers can choose when and where to display their ads to achieve the best results with least amount of spending.

In accordance with yet another aspect of the invention, the new targeted advertisement network can gather the viewing and sales history generated by the ads for each location and an effectiveness rating can be generated for each location and time, which provides feedback to the advertisers.

In accordance with yet another aspect of the invention, a desktop program in each terminal provides a unique user-interface suitable for accommodating many viewers in public places. The program will broadcast advertisements repeatedly if there are no viewer interactions. The ads have web-content format (dhtml, for example) so that the viewer can click on the ads and get many detailed information just like browsing ads in a web-site.

In accordance with one last aspect of the invention, a bidding platform can be built for the advertisers to bid for the locations and times of displaying their ads. the advertisers can have access to the viewing and sales data for each terminal to help them decide the return-on-investments for each terminal.

### BRIEF DESCRIPTION OF THE DRAWINGS

FIG. 1 is a schematic representation of the new targeted advertisement network in accordance with the invention.

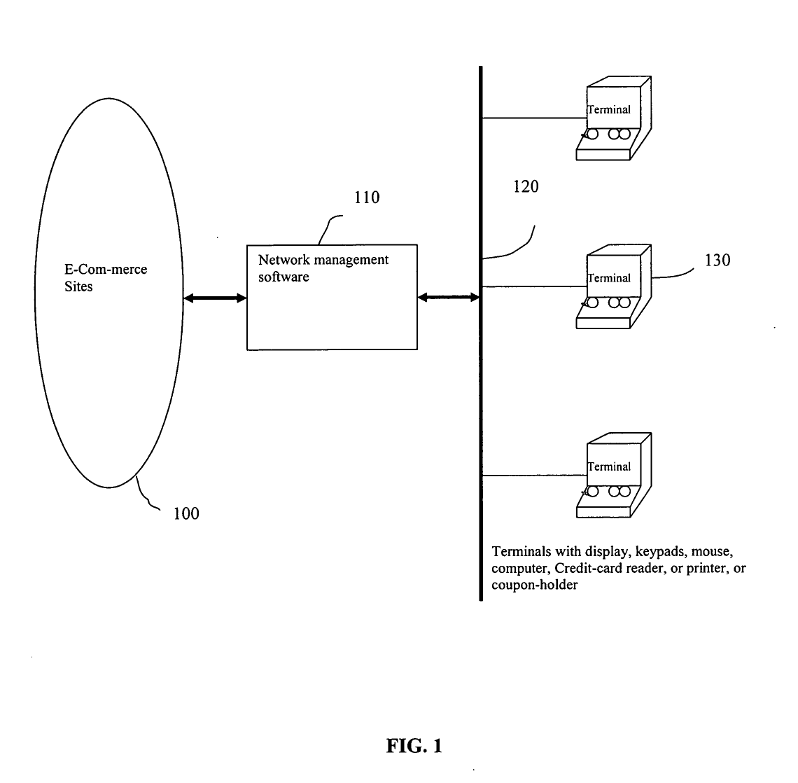

FIG. 2 is an example of the user-interface when there is no viewer interaction and a video is playing.

FIG. 3 is an example of the user-interface when there is no viewer interaction and several small ads are displayed in one page.

FIG. 4 is an example of the user-interface when there is user interaction, and ad category buttons are shown.

FIG. 5 shows an example of the daughter category of a parent button in FIG. 4

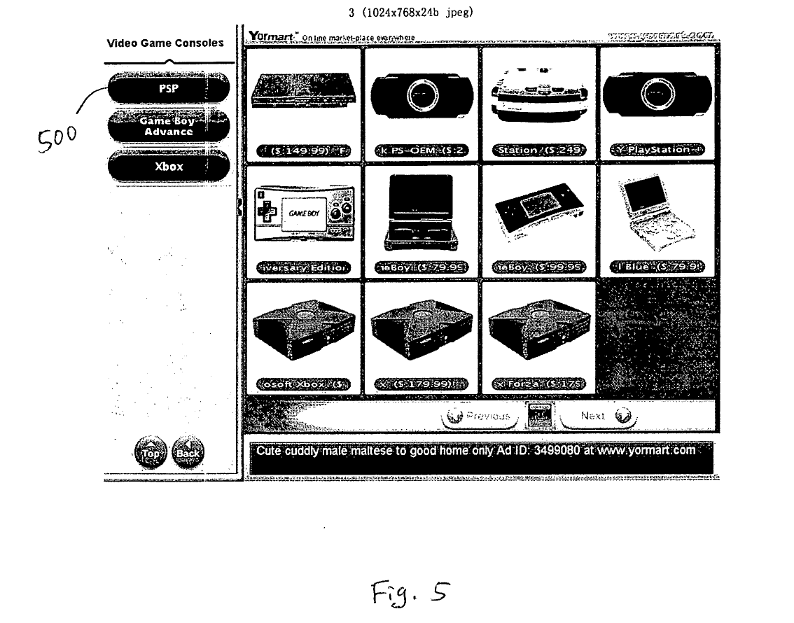

FIG. 6 shows an example of a detailed ad info. It is in web content format, or dhtml format.

### DETAILED DESCRIPTION OF THE INVENTION

The present invention relates to a new targeted advertisement network that integrates with store-shopping. The following description is presented to enable one of ordinary skill in the art to make and use the invention as provided in the context of a particular application and its requirements. Various modifications to the preferred embodiment will be apparent to those with skill in the art and the general principles defined herein may be applied to other embodiments. Therefore, the present invention is not intended to be limited to the particular embodiments shown and described, but is to be accorded the widest scope consistent with the principles and novel features herein disclosed.

The new targeted advertisement network may include at least one e-commerce site 100. A network of terminals 130 may be coupled to the e-commerce site 100 by means of a distributed network such as the internet 120. Each terminal 130 may include display, keypads, mouse, computers, credit card readers, printers and coupon holders. The e-commerce site 100 has secured log-ins for advertisers and store managers. The store managers are responsible for placing the terminals 130 and determine the viewers' profiles and best ad categories for each terminal 130. The store managers can then log into their accounts at the e-commerce site 100 and input how many terminals 130 they have placed and what categories of ads and what times are best for each terminal 130. With these detailed information of the terminals 130, the advertisers can choose when and where to place their ads, so that they can spend less and achieve better results.

A network management software 110 then makes the displaying schedule for each terminal 130, i.e. What ads to display and in what order to display. The network management software 110 then downloads the corresponding ads to each terminal 130 through internet 120, and save them in the local hard-disk of each terminal 130.

Each terminal 130 has a desktop program that runs the ads and interfaces with the viewer. That is. If the viewer is interested in one ad, he can click at the ad to get more detailed information about the ad. He can make the purchase using credit card, or he can print out a ticket or coupon which has basic product info and seller's info. He can then contact seller directly, or give the ticket to the cashier to check out, or he can simply go home and check out the product through the Yormart website.

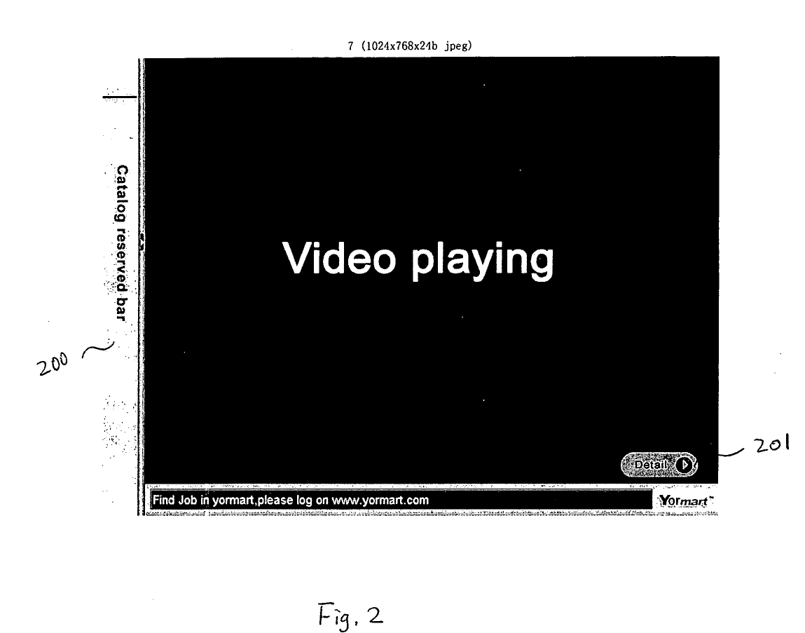

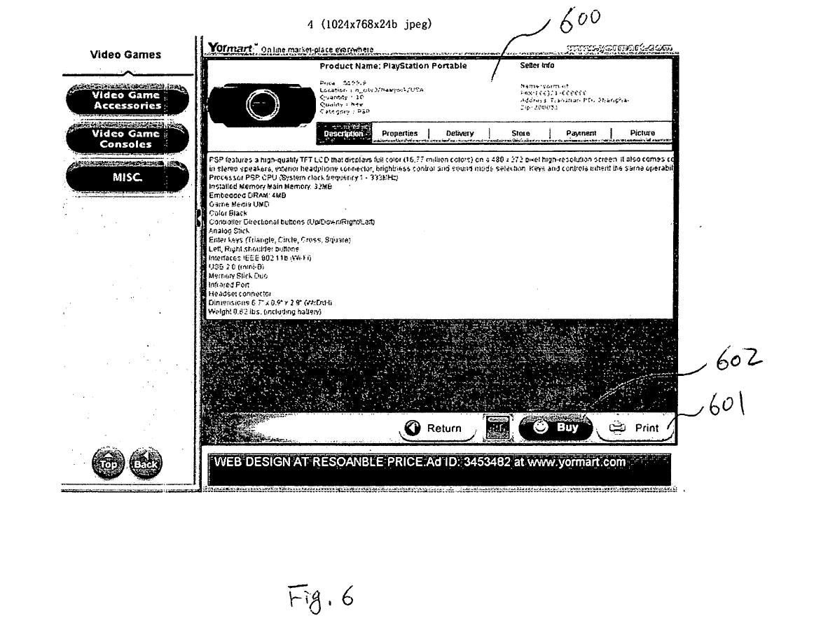

FIG. 2. shows the main state of the user-interface on terminals 130 when there are no viewer interactions and a video is playing. There is a “Detailed” button 201 that a viewer can touch to get more detailed information about the video ads. The detailed information 600 in FIG. 6 are in the web content format, or dhtml. A viewer can click on the ads and get many detailed information just like browsing ads in a web-site. In the detailed mode 600, the viewer may print out a ticket 601 showing information of the product and seller's contact information, or product's barcode. If the viewer is interested in buying the product, he can click on the buy button 602 to proceed.

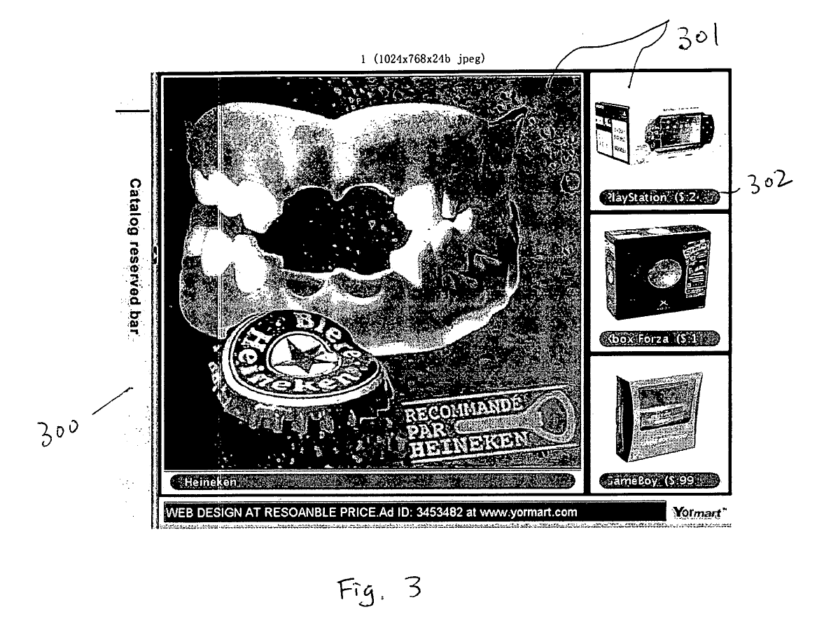

FIG. 3. shows the state of the user-interface when there are no viewer interactions and several small ads 301 are playing. The small ads 301 can be pure-picture ads or products ads as listed in the web-site, or a web content page (dhtml page), A viewer can touch each small ads to get more detailed information 600 about the ads. The detailed information 600 are in the web content format (dhtml format). The viewer can click on the ads and get many detailed information just like browsing ads in a web-site.

The small ads 301 can be a thumbnail image plus text info 302 such as the name of the product and its sales price. If the text info is too long to fit the allocated text space 302, the text will circulate or oscillate so that all texts will be shown.

The small ads 301 can be any size the advertiser requested. A desktop program automatically pick the small ads 301 and group them to fit one page to maximize the usage of the ad-spaces.

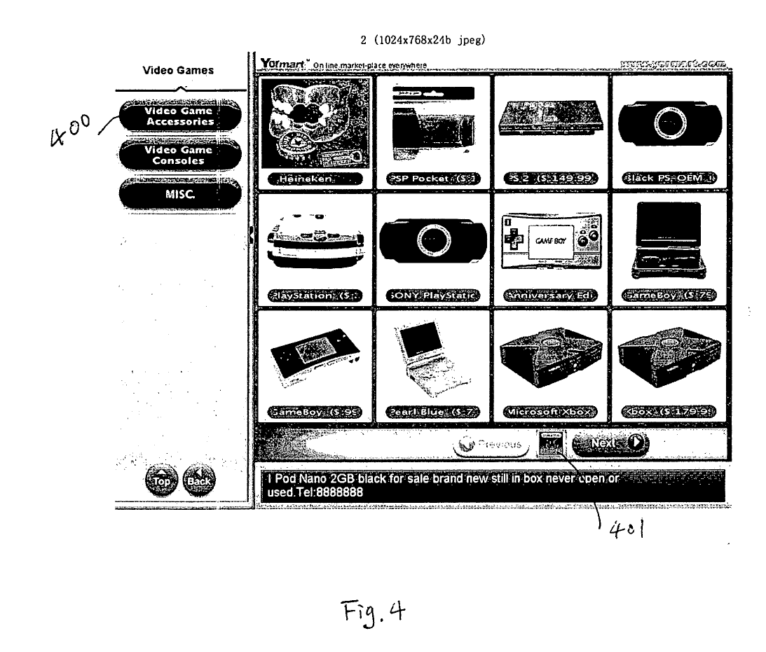

In FIG. 2 & FIG. 3, A viewer can touch the lefthand side bar 200 or 300 to enter the search mode FIG. 4. In addition to the ads shown in the auto-play mode FIG. 2 & FIG. 3, there are many more ads stored in the terminal that can be accessed through the search mode FIG. 4. There are some category buttons 400. A user can buy out a button 400 so that all of his ad listings are included under the button he bought. All of the rest of the listings not belonging to any user-bought-out buttons are included in the rest of the not-bought-out buttons. The button names are auto-generated according to the product directory trees of the e-commerce web-site 100 where the products are registered. Each button 400 can have children buttons 500 just like the web-site directory tree. A viewer can also touch any ads to see the detailed info 600 and print out a ticket 601 or click on buy button 602 to proceed to buy mode.

There is a time out feature 401 that will force the user-interface into the automatically broadcast mode if there are no user interactions within the time out period.

The desktop program also stores the viewer interface and sales history and uploads the data to the network management software 110. The data can be analyzed to establish an effectiveness rating for each terminal 130.

All the advertisements displayed at the public terminals 130 are available at the at least one e-commerce site 100, the buyer can also check out from the at least one e-commerce site 100. The buyers can also provide feedback for each Ad on when and where they saw the Ad. These feedback will also be used for the effectiveness rating system for all the terminals 130.

To save the cost of internet connections, a proxy server can be used to drive several terminals 130. The proxy server interacts with the e-commerce site 100 through the internet 120, while other terminals interact with the e-commerce site through the proxy server.

The following claims are therefore made:

1. A new targeted advertisement network comprising:
At least one on-line provider of advertisements;
A network of terminals coupled to the at least one on-line provider of advertisements;
A desktop program running on the terminals; and
A network management software.

2. The new targeted advertisement network of claim 1, wherein the on-line provider of advertisements sends ad contents to the network of terminals in web content format.

3. the new targeted advertisement network of claim 2, wherein the web content format consists of dhtml format

4. The new targeted advertisement network of claim 1, wherein the desktop program comprises a user-interface

5. The new targeted advertisement network of claim 4, wherein the user-interface stays in the automatically broadcast mode in which the ads are played repeatedly if there are no user-interactions

6. The new targeted advertisement network of claim 4, wherein ads played by the user-interface can be clicked to view more detailed information about the ads.

7. The new targeted advertisement network of claim 6, wherein a user can print out a ticket showing some basic information about the ad.

8. The new targeted advertisement network of claim 4, wherein the user-interface has a timeout feature that forces the interface into the automatically broadcast mode if there are no user-interactions within the timeout period.

9. The new targeted advertisement network of claim 4, wherein the texts describing the ad name and selling price will oscillate or circulate if they are too long to fit in the allocated space for texts.

10. The new targeted advertisement network of claim 4, wherein several ads with different sizes are grouped together to fit in one page automatically by a program.

11. The new targeted advertisement network of claim 5, wherein there is an area for viewer to select to enter ad search mode.

12. The new targeted advertisement network of claim 11, wherein ads are listed under their corresponding category buttons.

13. The new targeted advertisement network of claim 12, wherein the category buttons are generated automatically according to the product directory in the at least one on-line provider of advertisements.

14. The new targeted advertisement network of claim 12, wherein all of a user's listed ads in a terminal fall into one button if the user bought the right-of-use of the button.

15. The new targeted advertisement network of claim 1, wherein a terminal can be set as a proxy server so that several other terminals can be coupled to the at least one on-line provider of advertisements through the proxy server

16. The new targeted advertisement network of claim 4, wherein the user-interface comprises means of connecting to a viewer's cellphones or other PDAs (personal digital accessories)

17. The new targeted advertisement network of claim 16, wherein the means of connecting to a viewer's cellphones or other PDAs can be wireless.
